(19) United States
(12) Patent Application Publication
(10) Pub. No.: US 2024/0363320 A1
(43) Pub. Date: Oct. 31, 2024

(54) FIELD-EMISSION PHOTOCATHODES FOR HIGH-POWER HIGH-FREQUENCY ELECTRONICS

(71) Applicant: Lawrence Livermore National Security, LLC, Livermore, CA (US)

(72) Inventors: Clint Frye, Oakland, CA (US); Lars F. Voss, Livermore, CA (US); Joseph Devin Schneider, Danville, CA (US)

(21) Appl. No.: 18/309,237

(22) Filed: Apr. 28, 2023

(51) Int. Cl. H01J 40/06

(52) U.S. Cl. CPC H01J 40/06

(57) ABSTRACT

A vacuum electronic device is configured to provide electrical current that is configured to be optically modulated by incident light. The vacuum electronic device comprises an optically gated field emission photocathode comprising photoconductive material, an anode comprising a conductive material, and a gap between said photocathode and said anode. The gap comprises vacuum. The anode and photocathode are configured to receive a voltage across the anode and photocathode, such that when said photocathode is illuminated with said light, electrons are emitted from the photocathode and travel through the gap.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### BACKGROUND OF THE INVENTION

### Field of the Invention

The present disclosure relates generally to vacuum electronic devices, such as for example, vacuum electronic devices that can provide electrical current that can be optically modulated by incident light.

### Description of the Related Art

Current vacuum electronic devices (VEDs) used in radar, pulsed power, etc. are, in general, built on legacy vacuum tube technology. While VEDs perform well, VEDs are bulky, generally employ extremely hot cathodes (˜2000° C.) and have limitations in their ability to be miniaturized. VEDs generally employ a thermionic emission cathode, that is, a filament heated to about 2000° C. to “boil off” electrons into vacuum. This type of cathode fundamentally can limit miniaturization since structures close to the filament will also be heated. As a result, due to their large sizes, VEDs are often used in applications where size is less of a concern.

An alternative technology may employ a cold field emission cathode that produces electric field enhancement at a sharp conductive tip (e.g., made from silicon or molybdenum). Electrons in these tips experience high enough electric fields to quantum mechanically tunnel into vacuum at room temperature. This approach has conventionally involved the use of a third terminal, a gate electrode, to modulate the flow of electrons. However, such a gating mechanism generally limits the frequency performance of high-power vacuum transistors due to gate capacitance (Miller capacitance) and compromises voltage handling due to undesired electron collection at the gate electrode. In some cases, the gate is close to the cathode producing high capacitance that limits speed.

Thus, such technologies for generating a flow of electrons in vacuum have limitations.

### SUMMARY OF THE INVENTION

Vacuum microelectronics, however, have the potential to outperform silicon microelectronics by six orders of magnitude in high-power and high-frequency applications such as radar, high frequency wireless telecommunications, compact X-ray generation, and pulsed power. Advantageously, various implementations of vacuum electronic devices (VEDs) described herein can also be reduced to the size of a microchip. Such devices may be referred to as vacuum microelectronic devices (VMDs). The VEDs and VMDs described herein comprise reliable and optically addressable high-current cold cathode electron sources. An optically-gated field emission photocathode comprising, for example, wide bandgap (WBG) and ultra-wide bandgap (UWBG) semiconductors that are photoconductive can be disposed with respect to an anode such that a high voltage can be applied across the photocathode and anode. In various implementations, devices with larger bandgaps such as comprising WBG and UWBG semiconductors have lower leakage in the off state when the current is to be as low. Otherwise, some current may flow when the device is off. In some cases, thermal excitation of carriers causes leakage. In various designs, this photocathode, which is exposed to a strong electric field and is photoconductive, can emit electrons upon being illuminated with incident light. By using light to turn the cathode on and off, extremely fast pulse rates can be obtained, while simultaneously reducing or eliminating parasitic current leakage. In some cases, these pulse rates may correspond to the pulse rates of optical pulses from femtosecond lasers directed onto the photocathode.

Various implementations described herein, for example, comprise a vacuum electronic device configured to provide electrical current configured to be optically modulated by incident light. The vacuum electronic device comprises an optically gated field emission photocathode comprising photoconductive material, an anode comprising a conductive material, and a gap between said photocathode and said anode. The gap comprises vacuum. The anode and photocathode are configured to receive a voltage across the anode and photocathode, such that when said photocathode is illuminated with said light, electrons are emitted from the photocathode and travel through the gap.

Some implementations described herein comprise a hybrid vacuum microelectronic device (VMD) architecture that realizes the properties of vacuum as the electronic medium and the compact form factor and manufacturing scalability of semiconductor microelectronic chips. Some VEDs descried herein may be implemented as vacuum tubes. These vacuum tubes have cathodes and anodes wherein the cathode is photoconductive. These vacuum tubes do not require an electronic gate to gate the flow of electrons from the cathode.

### BRIEF DESCRIPTION OF THE DRAWINGS

The drawings described herein are for illustrative purposes only of selected embodiments and not all possible implementations and are not intended to limit the scope of the present disclosure.

Corresponding reference numerals indicate corresponding parts throughout the several views of the drawings.

FIG. 1 is a schematic illustration of a vacuum electronic device comprising an optically-gated field emission photocathode and an anode separated by a gap across which high voltage is applied. The field emission photocathode may comprise a wide band gap or ultra-wide band gap semiconductor that may be exposed to light such as a laser pulse causing the emission of an electrode.

FIG. 2 is a schematic illustration of a general architecture for a vacuum electronic device, possibly a vacuum micro-electronic device, comprising an optically gated field emission photocathode comprising, for example, an ultra-wide band gap semiconductor on a first substrate spaced apart from a second substrate by spacers. An electrically conductive layer forming an anode is disposed on the second substrate. The first and second substrates as well as the photocathode and anode are separated by a gap comprising vacuum. Voltage is shown applied to the anode and photocathode while light is incident on the photocathode.

FIG. 3A is a schematic illustration of an example field-emission photocathode in an electric field induced by applying a voltage between the photocathode and the anode without laser light incident thereon.

FIG. 3B is a band diagram showing that in the off state, electrons are trapped mid-gap in the semiconductor and have insufficient energy to cross the energy barrier to vacuum.

FIG. 4A is a schematic illustration of the example field-emission photocathode in an electric field induced by applying a voltage between the photocathode and the anode with laser light incident thereon.

FIG. 4B is a band diagram showing that in the on state, electrons are excited to the conduction band, which decreases and narrows the energy barrier allowing electrons to tunnel into the vacuum.

FIG. 5 is a theoretical plot on axes of Log (Current) (in relative units) and 1/Voltage (in relative units) schematically illustrating the dependency of current emission on inverse voltage applied to a WBG or UWBG field-emission photocathode tip in configurations such as shown in FIGS. 1 and 2.

FIG. 6A is a scanning electron microscope image showing a plurality of nano-tips on a SiC surface of the field emission photocathode.

FIGS. 6B-6E are scanning electron microscope images showing a plurality of pillars or tips having a micrometer scale on a SiC surface of the field emission photocathode.

FIG. 6F is a scanning electron microscope image showing a SiC surface of the field emission photocathode comprising nanometer scale structures comprising a plurality of apexes and valleys.

FIGS. 7A-7C are images of portions of the surface of the field emission photocathode having nanometer scale texture.

### DETAILED DESCRIPTION OF THE PREFERRED EMBODIMENT

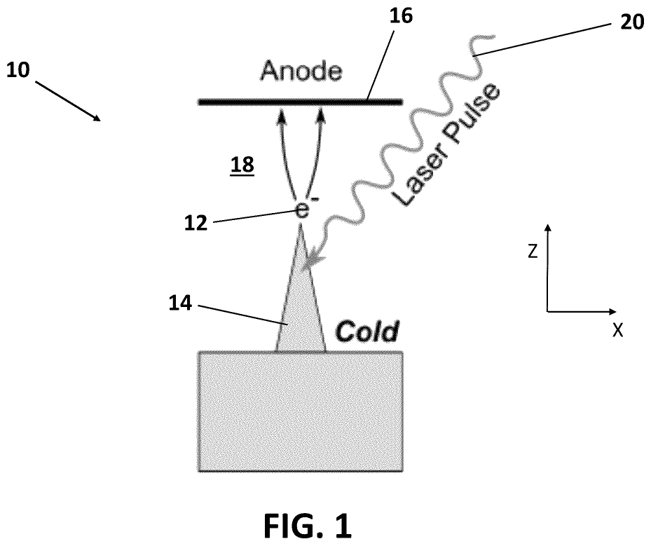

FIG. 1 illustrates an example vacuum electronic devices (VED) 10 that can provide as output a plurality of or stream of electrons 12. As shown, this device 10 may comprise a field emission photocathode 14 and an anode 16 separated by a gap 18. This gap 18 may comprise vacuum. Accordingly, vacuum may be disposed between the cathode 14 and anode 16.

A voltage is applied between the anode 16 and cathode 14 and across the gap 18. As shown, in various implementations, the field emission photocathode 14 comprises one or more microfeatures or nanofeatures that enhance the electric field and facilitate emission of electrons therefrom. The field emission photocathode 14 shown in FIG. 1, for example, comprises a tip having an apex. In various implementations, this field emission photocathode may also comprise a material that is photoconductive. Such material may comprise for example a semiconducting or semi-insulating material having a band gap. This material is illuminated light 20, for example, having the appropriate wavelength such as a wavelength having corresponding a photon energy that causes electrons to be energized with sufficient energy to transition into the conduction band. As a result, the material may become conductive when this light is directed onto the material. For some designs, the material comprises wide band gap semiconductor or ultra-wide band gap semiconductor. Either the wide band gap or ultra-wide band gap semiconductors may be semi-insulating. Such material may include, for example, silicon carbide (SiC), gallium nitride (GaN), diamond, gallium oxide (Ga₂O₃), aluminum nitride (AlN), and aluminum gallium nitride (AlGaN or AlₓGa₁₋ₓN). Some wide bandgap materials include gallium nitride and silicon carbide. Some ultra-wide bandgap materials comprise gallium oxide, diamond, aluminum nitride, and aluminum gallium nitride. In some designs, the material is doped and thus may comprise doped semiconductor or doped semi-insulating material. In some implementations, the semiconductor is doped p-type. The wide bandgap material, e.g., semiconductor, may have a band gap from 3 eV to 3.5 eV, whereas the ultra-wide bandgap material, e.g., semiconductor, may have a band gap from 3.5 eV to 6 eV or 8 eV or possibly higher or lower. In some implementation, this light comprises laser light. This light may or may not be pulsed.

When this photoconductive material is illuminated such that electrons transition into the conduction band and the photocathode 14 becomes conductive, electric field enhancement may be produced at the apex of the microstructure or nanostructure, e.g., tip or pillar on the surface of the photocathode. The photocathode 14 becomes an electron source, emitting electrons 12 (e.g., an electron stream) therefrom as illustrated in FIG. 1. In the presence of the strong electric field, the electrons 12 are ejected from the solid material comprising the photocathode 14 into vacuum 18. In some implementations, electric field enhancement at the sharp conductive tip(s) causes electrons 12 to quantum mechanically tunnel electrons into vacuum 18 at room temperature. Such a cathode 14 may be referred to as a cold cathode as heating the cathode to high temperature is not a requirement for emission of electrons.

This vacuum device 10 therefore produces an electron stream or current that is activated with illumination of the light 20 onto the photocathode 14. Accordingly, the device 10 is an optically activated electron or current source. Likewise, the emission current can be modulated through the production of photoexcited electrons by light from a pulsed light source such as a pulsed laser. The strong electric field applied between the anode 16 and the photocathode 14 both facilitate the ejection of electrons from the photocathode and their movement in the longitudinal direction (e.g., direction parallel to the z-axis) toward the anode.

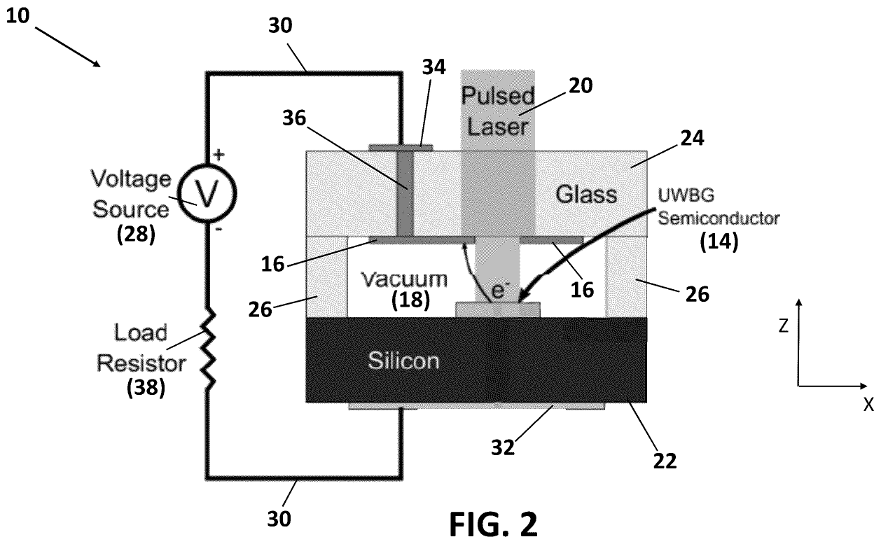

Such a device architecture may be reduced to microchip dimensions to produce micro-vacuum devices or vacuum microelectronics devices (VMDs). The VED design such as shown in FIG. 1 could be packaged into a vacuum chip to create a high power and/or high frequency vacuum microdevice (VMD). A device configuration that may be used for such a VMD is shown in FIG. 2.

The vacuum electronic device 10 depicted in FIG. 2 includes a photocathode 14 and an anode 16 separated by a gap 18. As discussed above, the photocathode 14 comprises a photoconductive material such as a semiconducting or semi-insulating material. In some implementations, the photocathode material comprises wide band gap semiconductor or wide band gap semi-insulating material. In some implementations, the photocathode material comprises ultra-wide band gap semiconductor or ultra-wide band gap semi-insulating material. The photocathode 14 may, for example, comprise silicon carbide (SiC), gallium nitride (GaN), diamond, gallium oxide (Ga₂O₃) aluminum nitride (AlN), or aluminum gallium nitride (AlGaN or AlₓGa₁₋ₓN). The photoconductive material may be dope or undoped. As discussed above, in various implementations, the photocathode 14 has surface with structure (e.g., microstructure or nanostructure) that are shaped to have high aspect ratio features (e.g. pillars, needles, tips, points, etc.) over the surface in either an array or in a random arrangement, possibly a random but uniform arrangement (such as uniform surface texturing). In some implementations, for example, the features are randomly arranged but have one or more properties such as a size range and/or density of features that are the same e.g., within 30%, 25%, 20%, 10%, 15%, 5%, 2%, 1% or any range formed by any of these values or possibly higher or lower, over an area (e.g., 0.5 μm², 1 μm², 10 μm², 25 μm², 50 μm², 100 μm², 500 μm², 1000 μm², 5000 μm², 10,000 μm², 50,000 μm², 100,000 μm², 1,000,000 μm², 10,000,000 μm², 100,000,000 μm² or any range formed by any of these values or possibly larger or smaller). The arrangement may or may not be in the form of a grid or ordered array. The anode 16 may comprise a layer of conducting material such as metal (e.g., gold, silver, etc.) or a transparent conductor (e.g. transparent conductive oxides, conductive semiconductors, etc.). Other materials and configurations may also be employed.

In some implementations such as shown in FIG. 2, the field emission photocathode 14 may be formed on and/or be part of a first substrate 22. The photocathode 14, for example, may comprise a layer formed or disposed on the first substrate 22. In some cases, this first substrate 22 comprises semiconductor such as silicon (Si). In some cases, the photocathode 14 comprises a layer of semiconductor such as a layer of SiC on the substrate. The anode 16 may also be disposed on and/or form part of a second substrate 24. In some implementations, this second substrate 24 may comprise a dielectric. This second substrate 24 may comprise material that is optically transmissive or transparent, at least to light 20 directed onto the photocathode 14 to optically activate the device 10 and the flow of electrons 12 from the photocathode. This second substrate 24 may, for example, comprise glass. In the example shown, the anode 16 also has a hole, opening or aperture through which the light 20 can pass. In other implementations, the anode 16 may comprise a layer of material such as a layer of conducting material that is optically transmissive or transparent to the light 20. Likewise, as illustrated, in this example light 20 from a light source (not shown) is directed through the second substrate 24, through the anode (e.g., through the hole, opening or aperture in the anode) and is incident on the photocathode 14. In some implementations this light source comprises a pulsed light source. This light source may also comprise a laser or laser source. In some implementations, this light source comprises a pulse laser or pulsed laser source.

Although in the design shown in FIG. 2, the light 20 passes through the second substrate 24 to access the photocathode 14, in other implementations, the light may be transmitted through the first substrate 22 to be incident on the photocathode. Accordingly, in some designs, the first substrate 22 comprises a material that is optically transmissive or optically transparent to the light 20 that is to be directed onto the photocathode 14. In some implementations, light from both sides of the photocathode 14 may be incident thereon. For example, light 20 may pass through the first substrate 22 to reach the photocathode 14. Light 20 may also pass through the second substrate 24 as well as the anode 16 (e.g., through a hole, opening or aperture in the anode) to be incident on the photocathode 14. Likewise, in some implementations both the first and second substrates 22, 24 may be optically transmissive or transparent to the light 20 to be directed onto the photocathode 14.

The first and second substrates 22, 24 are separated by spacers 26. This separation also provides for the gap 18 between the photocathode 14 and the anode 16. The distance between the cathode 14 and the anode 16 or the gap may be from 0.1 micrometer or micron (μm) to 1 μm or from 1 μm to 100 μm or from 100 μm to 10 mm or any range formed by any of these values or possible larger or smaller.

As discussed above, the gap 18 comprises vacuum. This vacuum may be created, for example, by at least partially fabricating the device 10 in an evacuated environment (e.g., chamber). For example, the first and second substrates 22, 24 having the cathode 14 and anode 16 formed thereon can be combined together with the separation 18 therebetween established by the spacers 26 in such an evacuated environment. In some implementations, the spacers 26 provide a seal such as a hermetic seal such that the gap 18 between the cathode 14 and the anode 16 and the first and second substrates 22, 24 remains a vacuum in comparison, for example, to outside the device 10 which may be at ambient. Other configuration and methods of fabrication are possible.

FIG. 2 further includes a voltage source 28 configured to apply a voltage across the cathode 14 and the anode 16. Electrical lines 30, e.g., are show electrically connecting the voltage source 28 to cathode and anode contacts 32, 34. The cathode contact 32 may comprise, for example, a conducting layer formed on the side of the first substrate 22 opposite the photocathode 14 and the gap 18. The anode contact 34 may also comprise a conductive layer on the side of the second substrate 24 opposite the anode 16 and the gap 18. In the example depicted in FIG. 2, this layer 34 is electrically connected to a via 36 through the second substrate 24 that is electrically connected to the anode 16. A load resistor 38 is also shown in series with the voltage supply 28. In various implementations, this resistor represents different external component wherein the power is to be switched. This load resistor, for example, could be an antennae or some other “load”. In various implementations, the voltage source 28 is configured to apply a voltage between the photocathode 14 and anode 16 and across the gap 18 that is from 0V to 100V, 100V to 1 kV, 1 kV to 100 kV, or any in any range formed by any of these values or voltages possibly larger or smaller.

In some example implementations, the photocathode 14 comprises, an WBG or UWBG (e.g. SiC, Diamond) material that is doped such that it is semi-insulating. The photocathode 14 may comprise material such as semiconductor that is doped to provide trap states such that electrons are trapped in these trapped states. These electrons may be excited by light 20 incident on the photocathode 14 such that these electrons transition into the conduction band possibly facilitating tuning into the vacuum.

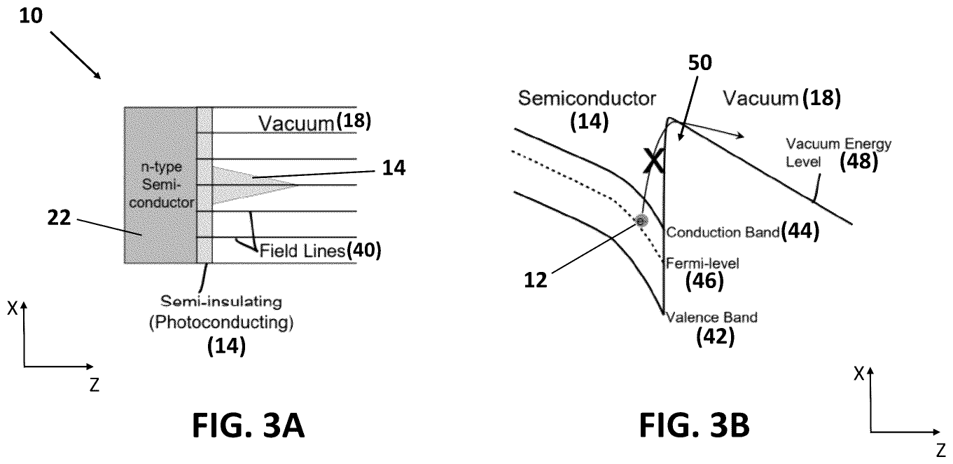

In an example method of operation, in the off state, the surface of the photocathode 14 is devoid of carriers. The photocathode material is semi-insulating and not conducting and is not illuminated with the light 20 so that electrons do not transition into the conduction band. Because the material comprising the photocathode 14 is not conducting, the electric field lines pass through the surface without significant field enhancement. FIG. 3A schematically depicts field lines 40 uniformly distributed across the photocathode 14 and not having increased concentration in any particular localized region. The emission current is limited in two ways. First, little current can flow due to the low number of electrons present in the semiconductor (i.e., the semiconductor is extremely resistive). Secondly, without field enhancement, the barrier for electrons to tunnel to vacuum is both high and wide further, limiting electron emission. A band diagram for this scenario is illustrated in FIG. 3B. The band diagram shows the semiconductor photocathode 14 having a valence band 42 and conduction band 44. An example Femi level 46 is also shown. The band diagram further shows the vacuum 18 having a vacuum energy level 48 that is high compared to the conduction band 44 and valance band 42. As a result, the band diagram depicts a tunneling barrier 50 as being high and wide without field enhancement in the off state. Likewise, the diagram shows an electron 12 at the Femi level 46 as not readily transitioning to into the vacuum 18.

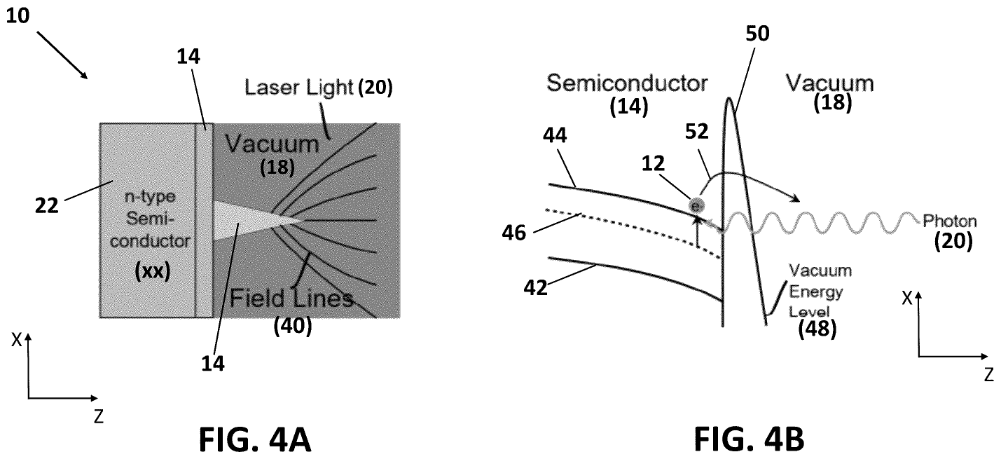

To turn the device on, a laser (or other light source) directs light 20 to the semiconductor or semi-insulating surface of the photocathode 14 to excite electrons to the conduction band 44 from traps mid-gap, for example, using sub-bandgap light. Photo-exciting carriers (e.g., electrons 12) has two main effects. One is that now mobile electrons 12 are in the semiconductor or semi-insulating material making the photocathode 14 conductive and allowing current to flow. Since the high aspect ratio features (e.g., pillars, tips, etc.) on the surface are conductive, the electric field lines 40 such as depicted in FIG. 4A concentrate on the tips, apexes, etc., creating field enhancement at the tip or apex. Field enhancement decreases the barrier width at the surface of the semiconductor or semi-insulating material forming the photocathode 14 enabling large numbers of electrons to tunnel into the vacuum 18. A band diagram for this scenario is illustrated in FIG. 4B. The band diagram shows the semiconductor photocathode 14 having a valence band 42 and conduction band 44 and an example Femi level 46. The band diagram further shows the vacuum 18 having a vacuum energy level 48 that is high compared to the conduction band 44 (although lower than when compared to the Fermi level 46) and valance band 42. However, the energy barrier 50 is thinner in this this band diagram for the on state. Additionally, the width of the energy gap to the vacuum energy is lower for an electron in the conduction band than for an electron in the trap state. As a result, the diagram shows an electron 12 excited form the Femi level 46 to the conduction band 44 as tunneling through the thinner barrier 50 and into the vacuum 18; see arrow 52. Photo-excitation and field enhancement can be used together or separately to modulate the electron emission from the surface of the photocathode.

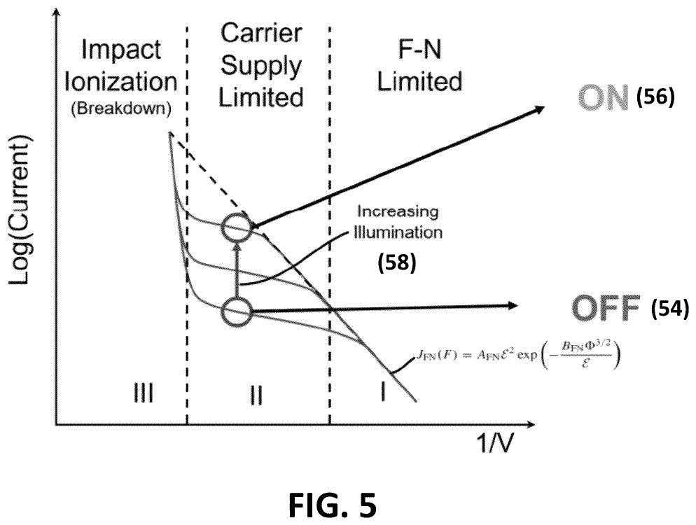

The current-voltage behavior of the WBG/UWBG field-emission photoconductor is expected to follow the relationship depicted in FIG. 5. The plot, on axes of Log (Current) and 1/Voltage schematically shows how the current (or at least log (current) varies with voltage or more particularly, 1/Voltage (or 1/V). V corresponds to the voltage from the voltage source 28 applied across the anode 16 and photocathode 14. The plot is separated into three regions. Region I is the region where the variation in current as a function of voltage, V, varies according to the Fowler-Norheim equation for field emission. This region corresponds to relatively low voltage, V, or high 1/V values. The current in this region of low voltage is limited by the tunneling of electrons. In Region II, where the voltage is higher than in Region I, the number of carriers limits the emission process. The voltage is not the barrier rather the number of carriers available to conduct is limiting. This is the region for operation where providing a light to the photoconductor 14 will vary the amount of electrons (or current or log (current)) emitted by the photocathode. Curved 54, for example, corresponds to the current produced for given voltages when the light 20 is not applied to the photocathode 14 and the device 10 is in the off state. Curved 56 corresponds to the current produced for given voltages when the light 20 is applied to the photocathode 14 and the device is in the on state. Arrow 58 shows the difference in current between these off and on states. Region II is the region of operation for various vacuum electronic devices described herein where the control (e.g., modulation on or off) of the incident light 20 may provide for control (e.g., modulation) of the emission of electrons 12 from the photocathode 14. Region III is the voltage level where avalanche breakdown of the semiconductor occurs. The voltage, V, is sufficiently high in this region to provide a multiplier effect where conduction and flow of electrons in the conduction band within the photocathode material via collisions causes movement of additional electrons producing a multiplier effect.

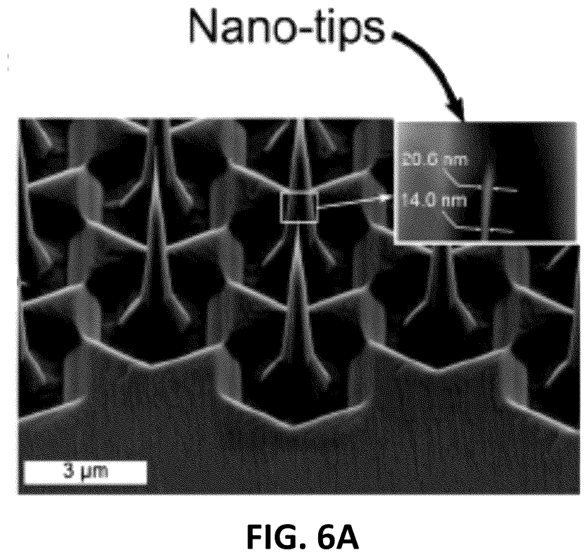

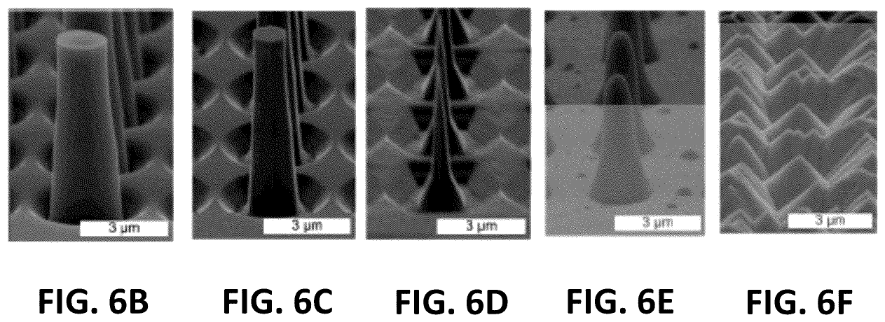

As discussed above, the electric field may be enhanced at a tip or apex of microstructure or nanostructure on the surface of the photocathode 14. FIGS. 6A-6F are scanning electron micrographs showing example microstructure and nanostructure having sufficiently a high aspect ratio that may be on the surface of the photocathode 14 to enhance the electric field. FIG. 6A, for example, comprises a plurality of tips formed in SiC using etching processes. The tips are relatively narrow having a full width at half maximum (FWHM) of from 10 to 25 nm, or from 14 to 20 nm. Such structures may be referred to as nanostructure. FIGS. 6B and 6C show larger pillars or tips formed in SiC having a width (e.g., FWHM) of about 2 microns or 1 micron, respectively. Such structures may be referred to as microstructure. FIG. 6D show smaller tips formed in SiC having a width (e.g., FWHM) of about 0.5 microns. FIG. 6E show tips formed in SiC having a curved top. The tips shown in FIGS. 6B and 6C have flat tops while the tips in FIGS. 6A and 6D have more sharply pointed tips. FIG. 6E shows microstructure that is shorter and wider tips formed in SiC, for example, having a width (e.g., FWHM) and height of about 1-2 microns. As illustrated, the microstructure or nanostructure may comprise features, e.g., tips, having an aspect ratio from 1:1 to 10:1, from 1.5:1 to 8:1, from 1.8:1 to 7:1, from 2:1 to 6:1 or any range formed by any of these values or possible aspect ratios that are higher or lower. In various cases, in principle, the higher the aspect ratio, the greater the field enhancement affect is. As discussed above, the microstructure or nanostructure may comprise features (e.g., tips, pillars, columns, needles, points etc.) that are arranged in an ordered arrangement or array or pattern such as shown in FIGS. 6A-6E or in a more random arrangement such as shown in FIG. 6F.

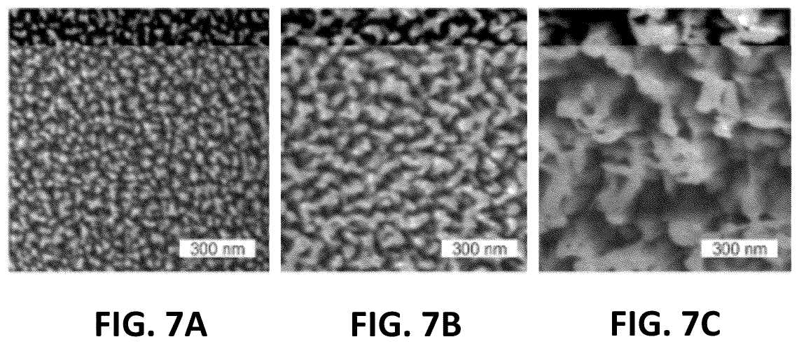

FIGS. 7A-7C show surfaces on SiC comprising microstructure or nanostructures possibly referred to as micro or nano texture that can potentially be used for the photocathode 14. These surface may include features that produce some electric field enhancement. The lateral size of the features in the surface may on average be from 10 to 100 nanometers (nm), 50 nm to 150 nm, from 150 nm to 1 micron, from 1 micron to 10 microns, or any in any range formed by any of the value or possibly larger or smaller. These features are randomly shaped and randomly distributed on the surface. Other surface configurations are possible. Likewise, the shapes can be random and/or the distribution, arrangement and/or location can be random.

A wide range of other variations in design are possible. In various designs, the photocathode 14 comprises material doped to be a semi-insulating photoconductor that is generally not conducting unless illuminated with light 20 having sufficient photon energy. In some cases, the material is co-doped. The material, which may comprise semiconductor material in some designs, may be doped with a first dopant to provide donors and another dopant to provide traps within the band gap such as traps in the band gap are close to the conduction band. These traps may trap carriers that can subsequently be excited from the trap state in the bandgap (and possibly close to the conduction band) into the conduction band when exposed to light 20 having sufficient photon energy for this transition. Light 20 having photon energy less than the bandgap may therefore be employed. In some cases, this light 20 may be infrared or visible (possibly UV) light. A semiconductor (e.g., SiC) may, for example, be co-doped with a first dopant (e.g., nitrogen) to produce donors (e.g., electrons) and thus may be N-type doped and with second dopant (e.g., vanadium) to produce traps in the band gap. When the semiconductor material (e.g., SiC) is illuminated with the light 20 having sufficient photon energy, electrons trapped in the traps can transition from the trap states into the conduction band. Moreover, as discussed herein, these electrons may tunnel through an energy barrier and into the vacuum and be ejected by the photocathode into the vacuum.

In various other designs, the photocathode 14 comprises semiconductor, e.g., WBG or UWBG semiconductor, that is p-type. In some such cases, although the semiconductor may be conductive, the surface is devoid of electrons as the p-type conductivity is based on holes. Likewise, the photocathode may not produce a stream of electrons simply by applying an electric field between the cathode 14 and anode 16. In some cases, however, above bandgap light 20 may be employed to activate the emission of electrons into the vacuum 18. Such light 20 can excite carriers from the valance band 42 into the conduction band 44. Additionally, the presence of such photoexcited carriers will change the tunneling energy barrier 50 making the energy barrier more conducive to tunneling into the vacuum 18 (e.g., by making the energy barrier thinner). Increased field concentration near the tip, the closest conducting feature to the anode 16, produces higher electric field strength proximal the tip and causes the energy barrier 50 to become narrower. As a result, providing light 20 having a photon energy greater than the bandgap may cause the photocathode 14 to emit a stream of electrons 12 directed toward the anode 16.

In other designs, the photocathode 14 may comprise a combination of a semi-insulating semiconductor with a p-type surface layer. In some cases, sub-bandgap light could be used. For example, in the case of the surface p-type layer, electrons could be excited from the trap state as discussed above however the excited electronics may drift across the p-type layer before tunneling to vacuum.

As discussed above, in some cases, the material comprising the photoconductor 14 may be doped to provide traps in the band gap. When light 20 is provided having sufficient energy to excite electrons trapped in these traps into the conduction band, the photoconductor can become conducting. Electrons 12 are available for emission from the photocathode 14 and the energy barrier may be reduced facilitating tunneling therethrough as well as emission of electrons from the material. In one example, diamond, which is generally insulating, is doped with nitrogen to provide electrons 12 just below the conduction band that are excited into the conduction band when light 20 of sufficient photon energy is directed onto the material. In some cases, infrared or visible or ultraviolet light may be used to excite electrons 12 into the conduction band and/or enable the photocathode 14 to emit electrons directed toward the anode 16.

In another variation, the photocathode 14 does not necessarily have high aspect ratio tips, microstructure or nanostructure. If the surface electron affinity is sufficiently low, then a flat surface that is photoconductive may be sufficient to produce emission of enough electrons when illuminated with light with application of high voltage. Such a photocathode 14 may comprise, for example, nitrogen doped and hydrogen-terminated diamond. Hydrogen-terminated diamond has a negative electron affinity, which means there is no energy barrier at the semiconductor-vacuum interface to impede the flow of electrons. In this example, the on/off state would be solely controlled by the photogeneration of carriers by the exposure to and/or pulsing of light.

As described above, the vacuum electronic devices (VEDs) may comprise vacuum micro-electronics (VMDs). The vacuum electronic device may comprise a microchip. The photocathode 14 and anode 16 could be packaged into a vacuum chip to create a high power and/or high frequency vacuum microdevice. FIG. 2 shows one such example configuration that may comprise a microchip or may be incorporated in a microchip. The vacuum micro-electronics, such as shown in FIG. 2 may, for example, be disposed on a substrate and/or have lateral dimensions from 10 μm to 1 mm, from 1 mm to 20 mm, from 20 mm to 100 mm or any range formed by these values or possibly may be larger or smaller.

In some implementations, however, field emission photocathodes 14 such as described herein can be packaged into a conventional vacuum tube, for example, replacing a hot cathode, possibly to create a high power and/or high frequency device. Such a vacuum electronic device 10 may comprise an anode 16 and cathode 14 wherein the cathode comprises photoconductive material, such as for example described herein. The photocathode 14 and anode 16 are separated by a gap 18 such as described herein. A voltage can be applied across the photocathode 14 and anode 16 as described above such that when the controlling light 20 is incident on the photocathode 14, a plurality or stream of electrons 12 is emitted by the photocathode 14 and is directed toward the anode 16. The photocathode 14 and anode 16 may be included in an enclosure (e.g., a tube), such as a glass enclosure (or glass tube) or metal enclosure (or metal tube) forming the vacuum tube. The environment within the enclosure may be evacuated such that the gap 18 between the photocathode 14 and the anode 16 comprises vacuum. Other configurations are possible.

In circumstances where high powers and/or high frequencies are needed (e.g. X-ray sources for cancer therapy, wireless telecom, radar, pulsed power), vacuum as an electronic medium outperforms any solid and is still used due to the near infinite mobility of electrons in free space (whereas electron transport in solids is limited by scattering off of atoms). Various device architectures describe herein employ semiconductor or semi-insulating material that may comprise, for example, wide band gap or ultra-wide bandgap material to eliminate the gate electrode altogether and instead provides optical gates using a field emission photocathode that is photoconductive. This device combines the simplicity of a two terminal (e.g., cathode 14 and anode 16) vacuum device 10 with the extremely fast pulse rate of an optical system such as a laser based system outputting fast optical pulses. Moreover, various designs of this vacuum electronics device 10 may comprise a microchip and have reduced size. Various designs described herein, for example, bridge the gap between VEDs and solid state electronics by creating a hybrid vacuum microelectronic device architecture that realizes the properties of vacuum as the electronic medium and the compact form factor and manufacturing scalability of semiconductor microelectronic chips. Various implementations of the architectures described herein can potentially increase performance of silicon power electronic chips by six orders of magnitude or reduce the volume and weight of a traditional VED by a factor of a thousand. Such an increase in power may enable new possibilities in portable X-ray sources, high bandwidth, high-power communications, low SWAP high resolution radar (e.g., lightweight drones for search and rescue), high power grid switching (efficient HVDC power transmission of renewable energy from remote locations), and wireless power beaming. The development of a field emission photocathode is not only an enabling technology for high-power and high-frequency microelectronics, but it can also potentially be used for electron sources for particle accelerators and electron microscopes.

In particular, various designs described herein include an optically-gated field emission photocathode from wide bandgap (WBG) and ultra-wide bandgap (UWBG) semiconductors as opposed to, for example, electrically-gated field emission cathodes, which can suffer from slower switching speed and higher parasitic currents to the gate electrode. By eliminating the electrical gate altogether and instead, using the optically modulated field emission photocathode design such as the field emission photocathode (e.g., wide band gap and ultrawide band gap field emission cathode), reduces or eliminates parasitic current to the gate that is used in electrically gated designs and increases the operating frequency as a result of reduced capacitance.

Various implementations described herein also bridge the gap between VEDs and solid-state electronics by creating a hybrid vacuum microelectronic device (VMD) architecture that realizes the properties of vacuum as the electronic medium and the compact form factor and manufacturing scalability of semiconductor microelectronic chips. This architecture will potentially increase performance of power electronic chips by six orders of magnitude or reduce the volume and weight of a traditional VED by a factor of a thousand.

### EXAMPLES

This disclosure provides various examples of devices, systems, and methods. Some such examples include but are not limited to the following examples.
1. A vacuum electronic device configured to provide electrical current configured to be optically modulated by incident light, said vacuum electronic device comprising:
   an optically gated field emission photocathode comprising photoconductive material;
   an anode comprising a conductive material; and
   a gap between said photocathode and said anode, wherein said gap comprises vacuum,
   wherein said anode and photocathode are configured to receive a voltage across the anode and photocathode, such that when said photocathode is illuminated with said light, electrons are emitted from said photocathode and travel through said gap.
2. The vacuum electronic device of Example 1, wherein said photoconductive material comprises a wide band-gap semiconductor.
3. The vacuum electronic device of Example 1, wherein said photoconductive material comprises a band-gap of from 3.0 eV to 3.5 eV.
4. The vacuum electronic device of Example 1, wherein said photoconductive material comprises an ultra-wide band-gap semiconductor.
5. The vacuum electronic device of Example 1, wherein said photoconductive material comprises a band-gap of from 3.5 eV to 8.0 eV.
6. The vacuum electronic device of any of Examples 1-5, wherein said photoconductive material comprises p-type semiconductor.
7. The vacuum electronic device of any of Examples 1-6, wherein said photoconductive material is doped so as to create defect states within the band gap such that light applied to the photoconductive material having an energy less than the band gap is sufficient to generate photocarriers that are emitted from the photocathode.
8. The vacuum electronic device of any of the Examples 1-6, wherein said photoconductive material comprises semiconductor doped to be semi-insulating such that the semiconductor is devoid of free carriers without application of light thereto having energy at least as large as the band gap to energize electrons into the conduction band.
9. The vacuum electronic device of any of the examples above, wherein said photoconductive material comprises SiC.
10. The vacuum electronic device of any of the examples above, wherein said photoconductive material comprises diamond.
11. The vacuum electronic device of any of Examples 1-10, wherein said optically gated field emission photocathode comprises a plurality of pillars, tips, or apexes formed of said photoconductive material.
12. The vacuum electronic device of any of Examples 1-10, wherein said photoconductive material comprises nanostructure configured to emit electrons.
13. The vacuum electronic device of any of Examples 1-10, wherein said photoconductive material has a surface electron affinity sufficiently low that photocarriers that are emitted from the photocathode upon illumination with said light.
14. The vacuum electronic device of Example 13, wherein said photoconductive material comprises nitrogen-doped and hydrogen-terminated diamond.
15. The vacuum electronic device of any of the examples above, further comprising a first substrate, said photoconductive material disposed on said first substrate.
16. The vacuum electronic device of Example 15, wherein said first substrate comprises a semiconductor substrate.
17. The vacuum electronic device of Example 16, wherein said semiconductor substrate comprises a doped semiconductor substrate, said first substrate further comprising a conductive laser or contact on a side of said first substrate opposite said photocathode configured to be electrically connected to said source of voltage.
18. The vacuum electronic device of Example 17, wherein said semiconductor substrate comprises doped silicon.
19. The vacuum electronic device of any of Examples 16-18, further comprising a second substrate, said anode disposed on said second substrate.
20. The vacuum electronic device of Examples 19, wherein said second substrate comprises a glass substrate.
21. The vacuum electronic device of any of Examples 19-20, wherein said first and second substrate are separated by spacers.
22. The vacuum electronic device of any of the examples above, further comprising a light source configured to illuminate said photocathode and generate photocarriers in said photoconductive material.
23. The vacuum electronic device of Example 22, wherein said light source comprises an IR light source, a visible light source or an ultraviolet light source.
24. The vacuum electronic device of Example 22 or 23, wherein said light source comprises a laser.
25. The vacuum electronic device of any of Examples 22-24, wherein said light source is configured to illuminate said photocathode by directing said light through said second substrate.
26. The vacuum electronic device of any of Examples 22-24, wherein said light source is configured to illuminate said photocathode by directing said light through said first substrate.
27. The vacuum electronic device of any of the claims above, wherein said light comprise laser light.
28. The vacuum electronic device of any of the examples above, packaged in a vacuum tube.
29. The vacuum electronic device of any of the examples above, packaged in a vacuum chip.
30. The vacuum electronic device of any of the examples above, further comprising at least one source of voltage configured to apply a voltage across said anode and photocathode such that when said photocathode is illuminated with said laser light, electrons are emitted from said photocathode and travel through said gap.

Although the description above contains many details and specifics, these should not be construed as limiting the scope of the invention but as merely providing illustrations of some of the presently preferred embodiments of this invention. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present invention fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present invention, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

What is claimed is:

1. A vacuum electronic device configured to provide electrical current configured to be optically modulated by incident light, said vacuum electronic device comprising:
an optically gated field emission photocathode comprising photoconductive material;
an anode comprising a conductive material; and
a gap between said photocathode and said anode, wherein said gap comprises vacuum,
wherein said anode and photocathode are configured to receive a voltage across the anode and photocathode, such that when said photocathode is illuminated with said light, electrons are emitted from said photocathode and travel through said gap.

2. The vacuum electronic device of claim 1, wherein said photoconductive material comprises a wide band-gap semiconductor.

3. The vacuum electronic device of claim 1, wherein said photoconductive material comprises a band-gap of from 3.0 eV to 3.5 eV.

4. The vacuum electronic device of claim 1, wherein said photoconductive material comprises an ultra-wide band-gap semiconductor.

5. The vacuum electronic device of claim 1, wherein said photoconductive material comprises a band-gap of from 3.5 eV to 8.0 eV.

6. The vacuum electronic device of claim 1, wherein said photoconductive material comprises p-type semiconductor.

7. The vacuum electronic device of claim 1, wherein said photoconductive material comprises SiC.

8. The vacuum electronic device of claim 1, wherein said photoconductive material comprises diamond.

9. The vacuum electronic device of claim 1, wherein said optically gated field emission photocathode comprises a plurality of pillars, tips, or apexes formed of said photoconductive material.

10. The vacuum electronic device of claim 1, wherein said photoconductive material comprises nanostructure configured to emit electrons.

11. The vacuum electronic device of claim 1, wherein said photoconductive material has a surface electron affinity sufficiently low that photocarriers that are emitted from the photocathode upon illumination with said light.

12. The vacuum electronic device of claim 1, further comprising a first substrate, said photoconductive material disposed on said first substrate.

13. The vacuum electronic device of claim 12, wherein said first substrate comprises a semiconductor substrate.

14. The vacuum electronic device of claim 13, wherein said semiconductor substrate comprises a doped semiconductor substrate, said first substrate further comprising a conductive laser or contact on a side of said first substrate opposite said photocathode configured to be electrically connected to said source of voltage.

15. The vacuum electronic device of claim 14, wherein said semiconductor substrate comprises doped silicon.

16. The vacuum electronic device of any of the claims above, further comprising a second substrate, said anode disposed on said second substrate.

17. The vacuum electronic device of claim 16, wherein said second substrate comprises a glass substrate.

18. The vacuum electronic device of any of claim 16, wherein said first and second substrate are separated by spacers.
